(19) United States
(12) Patent Application Publication
(10) Pub. No.: US 2006/0217514 A1
(43) Pub. Date: Sep. 28, 2006

(54) Room temperature curable organopolysiloxane compositions

(75) Inventors: Tadashi Araki, Gunma-ken (JP); Tsuneo Kimura, Gunma-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/386,676

(22) Filed: Mar. 23, 2006

(30) Foreign Application Priority Data
Mar. 24, 2005 (JP) 2005-085439

(51) Int. Cl. C08G 77/06

(52) U.S. Cl. 528/17; 528/34

(57) ABSTRACT

An RTV organopolysiloxane composition comprising an organopolysiloxane, an alkoxysilane compound containing, on the average, at least two silicon-bonded hydrolyzable groups and having a boiling point of at least 150° C. under normal pressure, and an organoxytitanium having a tertiary carbon atom bonded to an oxygen atom is easy to handle due to a high flash point, shelf stable, and adherent to resins, and gives off a less odor.

### CROSS-REFERENCE TO RELATED APPLICATION

This non-provisional application claims priority under 35 U.S.C. §119(a) on Patent Application No. 2005-085439 filed in Japan on Mar. 24, 2005, the entire contents of which are hereby incorporated by reference.

This invention relates to room temperature curable organopolysiloxane compositions, and more particularly, to room temperature curable organopolysiloxane compositions having many advantages including ease of handling due to a high flash point, shelf stability, resin adhesion, and a less odor, especially a less silane odor.

### BACKGROUND OF THE INVENTION

Various types of room temperature curable organopolysiloxane compositions which cure at room temperature upon contact with air-borne moisture are well known in the art. Among others, those compositions of the type that cure while liberating alcohol are preferentially used in sealing, bonding and coating of electric and electronic equipment, because they do not cause corrosion to metals.

One typical composition of the alcohol type is described in JP-B 39-27643 as comprising an organopolysiloxane end-blocked with hydroxyl groups, an alkoxysilane, and an organic titanium compound. Also JP-A 55-43119 discloses a composition comprising an organopolysiloxane end-blocked with alkoxysilyl groups, an alkoxysilane, and alkoxy titanium. Also, JP-B 7-39547 discloses an organopolysiloxane composition loaded with hydrophobic silica which remains fully stable during storage in the sealed state. It is described that a composition having shelf stability is not obtained if untreated silica is used. Additionally, JP-A 9-3330 discloses a composition using a titanium catalyst having a tertiary substituent group bonded to titanium, which has discoloration resistance and a high cure rate. JP-A 2001-152020 discloses a composition loaded with two types of calcium carbonate, which is improved in durable adhesion.

However, the compositions of JP-B 39-27643 and JP-A 55-43119 are less stable during shelf storage. JP-B 7-39547 suffers from several problems including expensive hydrophobic silica, changes with time of fluidity or unstable fluidity, and poor adhesion (especially to resins). When alkoxysilanes with a lower boiling point are used, a disgusting silane odor is perceivable. The composition of JP-A 9-3330 is inconvenient to handle due to a low flash point. The composition of JP-A 2001-152020 is less adherent to resins.

### DISCLOSURE OF THE INVENTION

An object of the present invention is to provide a room temperature curable organopolysiloxane composition having advantages including ease of handling due to a high flash point, shelf stability, resin adhesion, and a less odor, especially a less silane odor.

The inventor has discovered that by combining at least one organopolysiloxane having the general formula (1) or (2), shown below, with an alkoxysilane compound containing, on the average, at least two silicon-bonded hydrolyzable groups in a molecule and having a boiling point of at least 150° C. under normal pressure and/or a partial hydrolyzate thereof and an organoxytitanium in which on the average, 0.1 to 1.9 tertiary hydrocarbon groups of 4 to 10 carbon atoms are bonded to a titanium atom through an oxygen atom, a room temperature curable organopolysiloxane composition is obtainable which is easy to handle due to a high flash point, shelf stable, and adherent to resins, and gives off a less odor, especially a less silane odor.

Accordingly, the present invention provides a room temperature curable organopolysiloxane composition comprising

(A) 100 parts by weight of at least one member of organopolysiloxanes having the general formulae (1) and (2): 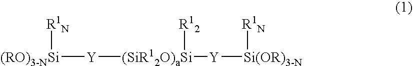
wherein R is methyl or ethyl, R¹ is substituted or unsubstituted monovalent hydrocarbon group of 1 to 10 carbon atoms, a is an integer of at least 10, Y is an oxygen atom or an alkylene group of 1 to 5 carbon atoms, and N is independently an integer of 0 or 1, 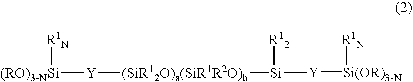
wherein R, R¹, a, Y and N are as defined above, R² is a hydrolyzable group-containing branched chain having the general formula: 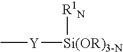
wherein R, R¹, Y, and N are as defined above, and b is an integer of at least 1,

(B) 0.1 to 20 parts by weight of an organoxysilane compound containing, on the average, at least two silicon-bonded hydrolyzable groups in a molecule and having a boiling point of at least 150° C. under normal pressure, a partial hydrolyzate thereof or a mixture thereof, and

(C) 0.1 to 15 parts by weight of an organoxytitanium having the general formula (3):
(R³O)_{c}Ti(OR⁴)_{4-c} (3)
wherein R³ is a tertiary hydrocarbon group of 4 to 10 carbon atoms in which the carbon atom bonded to the oxygen atom is tertiary, R⁴ is a substituted or unsubstituted monovalent hydrocarbon group of 1 to 10 carbon atoms excluding R³, and c is a positive number of 0.1 to 1.9 on the average.

The term “room temperature curable” is sometimes abbreviated as RTV.

### BENEFITS OF THE INVENTION

The RTV organopolysiloxane composition of the invention is easy to handle due to a high flash point, shelf stable, and adherent to resins, and gives off a less odor, especially a less silane odor.

### DESCRIPTION OF THE PREFERRED EMBODIMENTS

Component (A) which serves as a base polymer in the inventive composition is at least one organopolysiloxane selected from organopolysiloxanes having the general formulae (1) and (2). 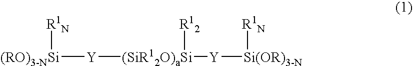
Herein R is methyl or ethyl, R¹ is substituted or unsubstituted monovalent hydrocarbon group of 1 to 10 carbon atoms, a is an integer of at least 10, Y is an oxygen atom or an alkylene group of 1 to 5 carbon atoms, and N is independently an integer of 0 or 1. 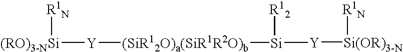
Herein R, R¹, a, Y and N are as defined above, R² is a hydrolyzable group-containing branched chain having the general formula: 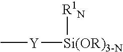
wherein R, R¹, Y, and N are as defined above, and b is an integer of at least 1.

In formulae (1) and (2), R is methyl or ethyl, with the methyl being preferred. R¹ is independently selected from substituted or unsubstituted monovalent hydrocarbon groups of 1 to 10 carbon atoms, preferably 1 to 6 carbon atoms, for example, alkyl groups such as methyl, ethyl and propyl, alkenyl groups such as vinyl, aryl groups such as phenyl, cycloalkyl groups such as cyclohexyl, and substituted forms of the foregoing in which some hydrogen atoms are replaced by halogen atoms, such as 3,3,3-trifluoropropyl. Of these, methyl, ethyl, vinyl, phenyl, and 3,3,3-trifluoropropyl are preferred, with the methyl being most preferred. A plurality of R¹ in formulae (1) and (2) may be the same or different.

Y is an oxygen atom or an alkylene group of 1 to 5 carbon atoms. Exemplary of the alkylene group are methylene, ethylene, propylene, and butylene. Of these, oxygen and ethylene are preferred.

Component (A) should preferably have a viscosity of 100 to 1,000,000 mPa·s at 25° C. With a viscosity of less than 100 mPa·s, the composition cures into an elastomer which may not be endowed with good physical properties, especially flexibility and elongation. With a viscosity of more than 1,000,000 mPa·s, the composition may become too viscous or undergo a substantial loss of fluidity. The viscosity of component (A) is more preferably from 300 to 100,000 mPa·s and most preferably from 500 to 50,000 mPa·s at 25° C. It is noted that the viscosity is measured by a rotational viscometer.

Component (B) is an organoxysilane compound containing, on the average, at least two, especially at least three silicon-bonded hydrolyzable groups in a molecule and having a boiling point of at least 150° C. under normal pressure, and/or a partial hydrolyzate thereof. The hydrolyzable groups are organoxy groups such as alkoxy groups. Besides the hydrolyzable groups, the organoxysilane compound has additional silicon-bonded organic groups. Such additional groups are not particularly limited while they are typically monovalent hydrocarbon groups of 1 to 10 carbon atoms, for example, alkyl groups such as methyl, ethyl and propyl, alkenyl groups such as vinyl, and aryl groups such as phenyl. The organoxysilane compounds should have a boiling point of at least 150° C. under normal pressure. Those organoxysilane compounds having a boiling point of less than 150° C. under normal pressure, such as methyltrimethoxysilane (b.p. 102° C.), methyltriethoxysilane (b.p. 143° C.) and vinyltrimethoxysilane (b.p. 123° C.) are undesirable because they may give off a strong odor.

Illustrative examples of the organoxysilane compound (B) include tetrafunctional alkoxysilanes such as tetraethoxysilane (b.p. 168.8° C.) and methyl cellosolve orthosilicate (b.p. 150° C./3 mmHg), trifunctional alkoxysilanes such as ethyltriethoxysilane (b.p. 160° C.), vinyltriethoxysilane (b.p. 158° C.), n-butyltrimethoxysilane (b.p. 164.8° C.), propyltrimethoxysilane, phenyltrimethoxysilane (b.p. 130° C./45 mmHg), octyltrimethoxysilane (b.p. 100° C./2 mmHg), and butyltrimethoxyethoxysilane, and partial hydrolytic condensates thereof. Even in the case of organoxysilane compounds having a boiling point of less than 150° C. under normal pressure, dimers or trimers obtained by hydrolytic condensation thereof are acceptable. These organoxysilane compounds may be used alone or in admixture.

A difunctional alkoxysilane may be additionally used in combination with the organoxysilane (B) when it is desired that the rubber elastomer after curing be endowed with low modulus. Exemplary difunctional alkoxysilanes are diphenyldimethoxysilane (b.p. 161° C./15 mmHg) and diphenyldiethoxysilane (b.p. 167° C./15 mmHg).

An appropriate amount of component (B) is in the range of 0.1 to 20 parts by weight, preferably 1 to 10 parts by weight per 100 parts by weight of component (A). Less than 0.1 pbw of component (B) fails to achieve sufficient crosslinking or form a composition having the desired rubber elasticity whereas more than 20 pbw of component (B) tends to retard the cure of compositions and form cured compositions with low mechanical properties and produces more odor.

Component (C) is a catalyst for helping the composition cure. It is an organoxytitanium having a tertiary carbon atom bonded to an oxygen atom, represented by the general formula (3):
(R³O)_{c}Ti(OR⁴)_{4-c} (3)
wherein R³ is a tertiary hydrocarbon group of 4 to 10 carbon atoms in which the carbon atom bonded to the oxygen atom is tertiary, R⁴ is a substituted or unsubstituted monovalent hydrocarbon group of 1 to 10 carbon atoms excluding R³, and c is a positive number of 0.1 to 1.9 on the average.

In formula (3), R³ is a tertiary hydrocarbon group of 4 to 10 carbon atoms, such as t-butyl or t-amyl, with the t-butyl being preferred. R⁴ is a substituted or unsubstituted monovalent hydrocarbon group of 1 to 10 carbon atoms excluding R³, of which preferred are primary or secondary hydrocarbon groups of 1 to 4 carbon atoms, such as methyl, ethyl, n-propyl, isopropyl, n-butyl and isobutyl.

The subscript c is a positive number of 0.1 to 1.9 on the average. Either a mixture of organoxytitanium compounds having different values of c within this range or an organoxytitanium compound having c=1 alone may be used.

Examples of the organoxytitanium compound of formula (3) include those with c=1 such as triisopropoxy-t-butoxytitanium, tributoxy-t-butoxytitanium, triisopropoxy-t-amyltitanium, and tributoxy-t-amyltitanium, and mixtures thereof with diisopropoxy-di-t-butoxytitanium or dibutoxy-di-t-butoxytitanium.

Component (C) is added in amounts of 0.1 to 15 parts by weight, preferably 1 to 10 parts by weight per 100 parts by weight of component (A). Outside the range, less amounts of component (C) fail to ensure storage stability and require a longer time until the inventive composition is fully cured. Inversely, excessive amounts of component (C) give rise to problems including rapid surface curing, retarded depth curing, and poor storage stability.

In addition to the foregoing components (A) to (C), the RTV organopolysiloxane composition in a preferred embodiment further comprises (D) an inorganic filler. The filler may be a reinforcing or non-reinforcing filler as long as it can impart good rubber physical properties to the inventive composition. The filler can improve the flow of the composition prior to curing and impart necessary mechanical properties to the rubbery elastomer after curing. Examples of suitable inorganic fillers include finely divided quartz, fumed silica, precipitated silica, calcium carbonate, fumed titanium dioxide, diatomaceous earth, aluminum hydroxide, microparticulate alumina, magnesia, zinc oxide, and zinc carbonate. They may be surface treated with silanes, silazanes, low-degree-of-polymerization siloxanes, and organic compounds. Of these, fumed silica and calcium carbonate are preferred.

Preferably the filler (D) is compounded in amounts of 1 to 500 parts by weight, more preferably 5 to 300 parts by weight, most preferably 10 to 200 parts by weight per 100 parts by weight of component (A). Too small amounts of the filler may fail to provide the desired effect. With too much amounts of the filler, the composition may have too high a viscosity and become difficult to work.

In another preferred embodiment, (E) an inert silicone fluid, preferably a polydimethylsiloxane capped with trimethylsilyl groups at both ends is compounded in the inventive composition. Compounding component (E) can improve flow and modify rubber physical properties after curing.

Component (E) should preferably have a viscosity of 5 to 50,000 mPa·s, more preferably 50 to 5,000 mPa·s at 25° C. Too low a viscosity may lead to a decline of rubber physical properties and allow excessive oil bleeding. Too high a viscosity may cause a viscosity buildup to the composition which becomes difficult to work. It is noted that the viscosity is measured by a rotational viscometer.

Component (E) is preferably compounded in amounts of 0 to 100 parts by weight, especially 5 to 80 parts by weight per 100 parts by weight of component (A). More than 100 pbw of component (E) may lead to a decline of rubber physical properties.

In the room temperature curable organopolysiloxane composition of the invention, (F) a silane coupling agent is preferably compounded. The silane coupling agent functions to improve the adhesion of the inventive composition. Any of well-known silane coupling agents may be advantageously used including (meth)acrylic silane coupling agents, epoxysilane coupling agents, aminosilane coupling agents, and mercaptosilane coupling agents. Examples include
γ-methacryloxypropyltrimethoxysilane,
β-(3,4-epoxycyclohexyl)ethyltrimethoxysilane,
γ-glycidoxypropyltrimethoxysilane,
γ-glycidoxypropylmethyltriethoxysilane,
N-β-(aminoethyl)-γ-aminopropyltrimethoxysilane,
γ-aminopropyltriethoxysilane, and
γ-mercaptopropyltrimethoxysilane.

Component (F) is preferably compounded in amounts of 0 to 10 parts by weight, more preferably 0.1 to 5 parts by weight per 100 parts by weight of component (A). The silane coupling agent need not be used if the composition even in the absence of silane coupling agent adheres to a substrate, depending on a particular type of filler and substrate. When the silane coupling agent is used, more than 10 pbw is economically disadvantageous.

In the room temperature curable organopolysiloxane composition of the invention, other well-known additives such as organic solvents, mildew-proofing agents, flame retardants, heat resistance modifiers, plasticizers, adhesion promoters, curing promoters, and pigments may be added as long as they do not adversely affect the objects of the invention.

The inventive composition is obtainable by mixing components (A) to (C) and optional components and additives, preferably in a moisture-shielded atmosphere. The composition thus obtained can be handled as a one package type RTV organopolysiloxane composition in that it is received in a sealed container for storage and on use, exposed to air-borne moisture whereupon it cures into a rubbery elastomer.

The inventive composition may find use in various fields, for example, as sealants for buildings, sealants for electric and electronic parts, adhesives, moisture-proof coatings, and coatings and adhesives for fibrous, glass, metal, and plastic articles.

### EXAMPLE

Synthesis Examples, Examples and Comparative Examples are given below for further illustrating the invention, but the invention is not limited thereto. All parts are by weight. Viscosity is a measurement at 25° C. by a rotational viscometer.

### Synthesis Example 1

A three-necked flask (internal volume 2 L) equipped with a thermometer, stirrer and condenser was charged with 2,500 g of α,ω-dimethylvinyl-dimethylpolysiloxane having a viscosity of 30,000 mPa·s, 400 g of toluene, 11.9 g of trimethoxysilane, and 1.0 g of a 50% toluene solution of chloroplatinic acid as a catalyst, which were stirred for 9 hours at room temperature in a N₂ stream. The reaction solution was then heated at 100° C. in a vacuum of 10 mmHg for distilling off the toluene as a diluent and the excess of trimethoxysilane, leaving 2,350 g of a colorless clear liquid having a viscosity of 40,000 mPa·s and a nonvolatile content of 99.9%. When this liquid was mixed with tetrapropyl titanate in a ratio of 100:1, it did not thicken immediately and cured after one day. This suggests the addition of the SiH group of trimethoxysilane to vinyl groups at polymer ends. This polymer is designated Polymer A.

### Example 1

A composition was prepared by mixing 100 parts of Polymer A with 50 parts of both end methyl-blocked polydimethylsiloxane and 20 parts of fumed silica surface treated with dimethyldichlorosilane (R972, Nippon Aerosil Co., Ltd.), and further mixing them with 8 parts of n-butyltrimethoxysilane (b.p. 164.8° C.), 5 parts of triisopropoxy-tert-butoxytitanium and 0.5 part of γ-glycidoxypropyltrimethoxysilane under moisture-shielded conditions until uniform.

### Comparative Example 1

A composition was prepared by the same procedure as in Example 1 except that 5 parts of isopropoxy-tri-tert-butoxytitanium was used instead of the triisopropoxy-tert-butoxytitanium.

### Comparative Example 2

A composition was prepared by the same procedure as in Example 1 except that 5 parts of tetra-tert-butoxytitanium was used instead of the triisopropoxy-tert-butoxytitanium.

### Comparative Example 3

A composition was prepared by the same procedure as in Example 1 except that vinyltrimethoxysilane (b.p. 123° C.) was used instead of the n-butyltrimethoxysilane (b.p. 164.8° C.).

The compositions of Example and Comparative Examples were shaped into sheets of 2 mm thick and cured in an atmosphere of 23±2° C. and RH 50±5% for 7 days, after which the physical properties (hardness, elongation at break, tensile strength) of the rubber sheets were measured according to JIS K6249. The operator smelled the compositions to see whether or not they gave an unpleasant odor.

Separately, the RTV compositions were coated onto resin adherends of 25×100×2 mm (thick) and held at room temperature until rubber elastomers were obtained. The adhesion of the cured coating to the adherend was visually examined by pulling the cured coating. The resin adherends used herein included those of hard polyvinyl chloride (PVC), polystyrene, polycarbonate (PC), and acrylic resin, which are commonly used as building material.

For classifying the compositions in terms of danger, the flash point of each composition was determined by a Seta flash closed cup tester according to ASTM D3278-1982.

A storage stability test was carried out by filling a cartridge with the uncured composition, heating the package in a dryer at 70° C., discharging the composition from the package, and allowing the composition to cure in an atmosphere of 23±2° C. and RH 50±5% for 7 days. Like the initial compositions, the aged compositions (or rubbers) were measured for physical properties and adhesion.

The results of Examples and Comparative Examples are shown in Table 1.

TABLE 1

| | | | Comparative Example | | |
|---|---|---|---|---|---|
| | | Example 1 | 1 | 2 | 3 |
| Initial | Tack-free time (min) | 3 | 3 | 3 | 3 |
| physical | Slump (mm) | 0 | 0 | 0 | 0 |
| properties | Flashpoint (° C.) | 50 | 38 | 35 | 48 |
| | Hardness (Durometer A) | 19 | 21 | 20 | 20 |
| | Elongation at break (%) | 400 | 400 | 360 | 360 |
| | Tensile strength (MPa) | 1.3 | 1.3 | 1.2 | 1.2 |
| | Odor | ◯ | ◯ | ◯ | X |
| Resin | Hard PVC | ◯ | ◯ | ◯ | ◯ |
| adhesion | Polystyrene | ◯ | ◯ | ◯ | X |
| | PC | ◯ | ◯ | ◯ | ◯ |
| | Acrylic | ◯ | ◯ | ◯ | ◯ |
| Aged | Tack-free time (min) | 6 | 4 | 3 | 4 |
| physical | Hardness (Durometer A) | 17 | 18 | 19 | 20 |
| properties | Elongation at break (%) | 520 | 490 | 450 | 450 |
| | Tensile strength (MPa) | 1.3 | 1.3 | 1.2 | 1.4 |

*1 resin adhesion
◯: good,
Δ: partially stripped,
X: poor
*2 odor
◯: acceptable,
X: unpleasant

Japanese Patent Application No. 2005-085439 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A room temperature curable organopolysiloxane composition comprising
(A) 100 parts by weight of at least one member of organopolysiloxanes having the general formulae (1) and (2): 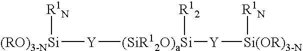
wherein R is methyl or ethyl, R¹ is substituted or unsubstituted monovalent hydrocarbon group of 1 to 10 carbon atoms, a is an integer of at least 10, Y is an oxygen atom or an alkylene group of 1 to 5 carbon atoms, and N is independently an integer of 0 or 1, 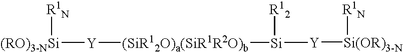
wherein R, R¹, a, Y and N are as defined above, R² is a hydrolyzable group-containing branched chain having the general formula: 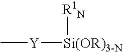
wherein R, R¹, Y, and N are as defined above, and b is an integer of at least 1,
(B) 0.1 to 20 parts by weight of an organoxysilane compound containing, on the average, at least two silicon-bonded hydrolyzable groups in a molecule and having a boiling point of at least 150° C. under normal pressure, a partial hydrolyzate thereof or a mixture thereof, and
(C) 0.1 to 15 parts by weight of an organoxytitanium having the general formula (3):
(R³O)_{c}Ti(OR⁴)_{4-c} (3)
wherein R³ is a tertiary hydrocarbon group of 4 to 10 carbon atoms in which the carbon atom bonded to the oxygen atom is tertiary, R⁴ is a substituted or unsubstituted monovalent hydrocarbon group of 1 to 10 carbon atoms excluding R³, and c is a positive number of 0.1 to 1.9 on the average.

2. The composition of claim 1, further comprising (D) 1 to 500 parts by weight of an inorganic filler.

3. The composition of claim 1, further comprising (E) 1 to 100 parts by weight of an inert silicone fluid.

4. The composition of claim 1, further comprising (F) 0.1 to 20 parts by weight of a silane coupling agent.
